(19) United States
(12) Patent Application Publication
(10) Pub. No.: US 2026/0310649 A1
(43) Pub. Date: Oct. 8, 2026

(54) DATABASE SYSTEMS AND CONSTRAINT MANAGEMENT METHODS WITH INSTANCE VARIABLE BINDING

(71) Applicant: Salesforce, Inc., San Francisco, CA (US)

(72) Inventor: Shaowei Mao, Bellevue, WA (US)

(73) Assignee: Salesforce, Inc., San Francisco, CA (US)

(21) Appl. No.: 19/173,676

(22) Filed: Apr. 8, 2025

(51) Int. Cl. G06F 16/23; G06F 9/451; G06F 9/455; G06F 16/28

(52) U.S. Cl. CPC G06F 16/2343; G06F 9/451; G06F 9/45558; G06F 16/288; G06F 2009/45583

(57) ABSTRACT

Database systems and methods are provided for managing relationships between records in a database. An exemplary method involves identifying a virtual container for a first record at the database system based on one or more fields of the first record and updating the virtual container to associate the first record with one or more additional records. In response to an operation with respect to at least one of the records, the method binds an instance variable of a virtual container based on a relationship between respective values associated with the respective records, automatically initiate an action at the database system with respect to the one or more respective records satisfying the relationship constraint, and update a graphical user interface (GUI) display at a client device over a network to include graphical indication of the action at the database system responsive to the bound value for the instance variable.

### TECHNICAL FIELD

One or more implementations relate to the field of database systems, and more specifically, to managing constraints or relationships across different types of records at a database system when configuring custom heterogenous groupings of different types of records.

### BACKGROUND

Modern software development has evolved towards web applications or cloud-based applications that provide access to data and services via the Internet or other networks. For example, social media platforms and other collaborative web sites allow users to exchange direct messages or form groups for broadcasting messages and collaborating with one another. In business environments and customer relationship management (CRM) contexts, communication platforms facilitate users sharing information about sales opportunities or other issues surrounding products or services and track changes to projects and sales opportunities by receiving broadcast updates about coworkers, files, and other project related data objects.

In contrast to traditional systems that host networked applications on dedicated server hardware, a “cloud” computing model allows applications to be provided over the network “as a service” or “on-demand” by an infrastructure provider. The infrastructure provider typically abstracts the underlying hardware and other resources used to deliver a customer-developed application so that the customer no longer needs to operate and support dedicated server hardware. Multi-tenant cloud-based architectures have been developed to support multiple user groups (also referred to as “organizations” or “tenants”) using a common hardware and software platform. Some multi-tenant database systems include an application platform that supports a customizable user experience, for example, to create custom applications, web pages, reports, tables, functions, and/or other objects or features.

In a CRM setting or other business context, different combinations or bundles of products or services are typically offered or utilized to build customers, increase revenue, and provide predictable growth and income streams. However, the underlying workflows, validation rules and other functionality supported by the application platform may be inflexible or limit a developer or organization from achieving the full range of customizations and combinations of different products or services that can be grouped or bundled together with the desired level of complexity and/or flexibility, such as, for example, add-ons, renewals, amendments, and/or the like. Additionally, it may be challenging to apply constraints, restrictions or other business logic across different heterogeneous and complex combinations of products and services to ensure compatibility and alignment with marketing strategies, development strategies or other objectives without configuration errors or reliance on complex queries or other operations that can increase latency, coding requirements, and/or the like. Accordingly, it is desirable to provide a flexible service capable of accommodating various customizations and combinations of different types of database records while applying desired constraints across those different heterogeneous and complex combinations of database records in a manner that mitigates configuration errors and improves user experiences.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a computing system that includes a constraint management service associated with a virtual application provided by an application platform at a database system according to some example implementations;

FIG. 2 depicts constraint modeling language (CML) code for a virtual container suitable for use with the constraint management service in the computing system of FIG. 1 according to some example implementations;

FIGS. 3-4 depict graphical user interface (GUI) displays suitable for presentation by an instance of the virtual application in connection with the constraint management service in the computing system of FIG. 1 according to some example implementations;

FIG. 5 is a flow diagram illustrating a constraint management process suitable for implementation by the constraint management service in the computing system of FIG. 1 according to some example implementations;

FIG. 6 depicts CML code for an exemplary constraint model including virtual containers suitable for use with the constraint management service in the computing system of FIG. 1 according to some example implementations;

FIG. 7 is a flow diagram illustrating an instance variable binding process suitable for implementation by the constraint management service in the computing system of FIG. 1 according to some example implementations;

FIG. 8 depicts a GUI display suitable for presentation by an instance of the virtual application in connection with the instance variable binding process of FIG. 7 according to some example implementations;

FIG. 9A is a block diagram illustrating an electronic device according to some example implementations; and

FIG. 9B is a block diagram of a deployment environment according to some example implementations.

### DETAILED DESCRIPTION

The following description describes implementations for applying constraints or rules across user-configurable and customizable groups, bundles or other combinations of different types of database objects or records supported by an application platform and/or a database system at different scopes or across different relationships between those objects or records associated with a particular group. For example, in the context of a virtual customer relationship management (CRM) application provided by an application platform of a database system, a particular user, organization or tenant of the database system may sell multiple different types of products (each of which may have different database object types or records associated therewith) that can be grouped, packaged or otherwise combined (e.g., as part of an order or subscription, to generate a quote or invoice, and/or the like), where that tenant may desire to enforce rules or other constraints based on different attributes of the product(s) being combined at different scopes, which may vary from other tenants and/or depending on the types of product(s) involved. For example, software as a service (Saas) products (corresponding to different database records or object types) may be provisioned on different tenants, where different “require,” “exclude,” and/or other business logic or rules are to be enforced for products associated with the same tenant to ensure compatibility or interoperability, alignment to marketing and/or sales strategies, and/or the like. At the same time, the products may be associated with or otherwise belong to different database records or object types (e.g., accounts, contacts, opportunities, and/or the like), where there are different “require” and/or “exclude” rules are to be enforced for products associated with the same account.

As described in greater detail below, one or more virtual containers are created that allow database objects or records to be allocated to different virtual containers to allow for different rules or constraints to be enforced based on different attributes of the respective database objects or records at different scopes, without requiring complex queries, searches, or other more complex database operations at run-time. In exemplary implementations, when a group of records is defined, created or otherwise configured at a database system, one or more virtual containers for the respective records are identified based on the values or other attributes of one or more fields of the respective records. The respective virtual containers are updated to associate a respective record with one or more additional records at the database system, and in response to an operation with respect to a field of the respective record, a constraint management service automatically detects or otherwise identifies a violation of a constraint associated with the virtual container based at least in part on a relationship between the value of the field of the record and one or more respective values for that field of one or more additional records associated with the respective virtual container. When violation of a constraint is detected, another field of the record is updated to include an indication of the constraint at the database system and utilized to generate or otherwise provide a graphical indication of a configuration error identifying the constraint that was violated in connection with a graphical representation of the record, thereby allowing a user to modify the definition or configuration of the record to satisfy the constraint and resolve the configuration error.

For example, for purposes of explanation, the subject matter is primarily described herein in the context of an instance of a virtual CRM application incorporating a service configurable to provide a product configurator, configure price quote (CPQ) tool or similar feature capable of generating quotes or perform other actions with respect to user-configurable or customizable combinations of products and services with varying degrees of complexity. In this regard, a user may select or otherwise configure different types of database objects or records corresponding to the respective products or services to be added to a particular quote, order, invoice or the like based on customer requirements. To apply constraints with respect to pricing, discounts, product bundling, upselling, cross-selling, dependencies and/or the like, the virtual CRM application incorporates or otherwise utilizes a constraint management service that identifies the appropriate virtual containers for associating the respective records belonging to a particular quote based on their respective attributes (e.g., type of product or service, number of product or service, and/or the like) and updates the virtual containers to maintain the desired associations between records, which could belong to the same quote or be associated with a different quote. Thereafter, in response to a user modifying or configuring a value for a particular field of a record or a create, read, update, and delete (CRUD) operation with respect to the record(s) belonging to the quote, the constraint management service utilizes the virtual containers to apply the respective rules, constraints or other business logic defined for the respective virtual container to the associated records to automatically detect or otherwise identify a violation of a constraint based on a relationship between the field value(s) or attribute(s) for a particular record belonging to the quote with respect to the field value(s) or attribute(s) for another record associated with that virtual container (which itself could belong to the same or different quote). In this manner, constraints may be applied across different types of records and/or across different quotes or orders.

When the constraint management service detects the violation of a constraint, the constraint management service automatically updates one or more fields of the records associated with the quote to include information or other indicia of the violated constraint, which, in turn, is utilized by the instance of the virtual CRM application to provide a corresponding graphical indication of the violated constraint to the user. In this manner, a user utilizing the product configurator, CPQ tool or similar feature of the virtual CRM application may identify the particular combination or configuration of products and/or services associated with the quote that violate constraints and how or why the constraints are violated, thereby allowing the user to modify the configuration of one or more of the products and/or services associated with the quote to satisfy the constraints.

By virtue of the subject matter described herein, rules, business logic or other constraints can be defined and applied across relationships between different database objects or records associated with a particular group or across different groups, without reliance on complex workflows, validation rules, queries or other database operations. Rather, the constraint management service utilizes a constraint management language (CML) to define a product model and define the hierarchical relationships between different database objects or records and their respective attributes. In exemplary implementations, the CML utilizes object-oriented modeling using a type entity, which represents a virtual container prototype of an entity to be defined by its attributes (integer numbers, decimal numbers, strings or text values, and Boolean logic values), relationships to other type entities (or ports), and corresponding constraints. For example, a quote or product type entity may be defined that includes a number of different child type entities using a port declaration to implement a “has a” relationship or otherwise define that constituent products or services to be associated with the quote. To define constraints to the quote or product type entity, the port declaration may incorporate cardinality to define the minimum and/or maximum number of child type entities required to be associated with the respective quote or product type entity, while attribute declarations may similarly constrained by minimum and/or maximum values. In this manner, virtual containers for each child product or service to be added to a quote may be defined with particular attributes (and corresponding constraints) and potentially ports or relationships to additional child type entities. Thereafter, a top-level virtual container for the quote may be defined with particular attributes (and corresponding constraints) along with different ports (and corresponding constraints) that define what child products or services are required to be included with the particular quote, the particular number of a particular type of child product or service is required to be included with the particular quote, and/or other constraints on the child products or services required to be included with the particular quote based on the respective attributes or configuration of other child products or services included with the particular quote. Thus, when a user attempts to configure a quote that does not include the requisite number or combination of child products or services or otherwise includes a configuration of child products or services that is constrained or otherwise prohibited based on the definition of the quote in the CML, a corresponding notification may be provided to the user with graphical indicia of the particular constraints violated and/or the like.

In practice, the virtual containers may be defined and designed in a visual, WYSIWYG, drag and drop, declarative, and low code (or no code) manner via one or more graphical user interface (GUI) displays using user-configurable web components that allow the user to define the respective different entity types, attributes, ports and corresponding constraints to be applied across virtual containers. The precise implementation details associated with such visual, WYSIWYG, drag and drop, declarative, or low code (or no code) designers are not germane to the subject matter and will not be described in detail herein. For reference, some examples of visual, low code (or no code) WYSIWYG design are described in U.S. Pat. No. 11,269,668, U.S. Pat. No. 11,321,422 and U.S. Pat. No. 11,797,638. That said, in other implementations, the virtual containers implemented by the constraint management service may be defined using a suitable integrated development environment or other code editor, which similarly is not germane to the subject matter and will not be described in detail herein.

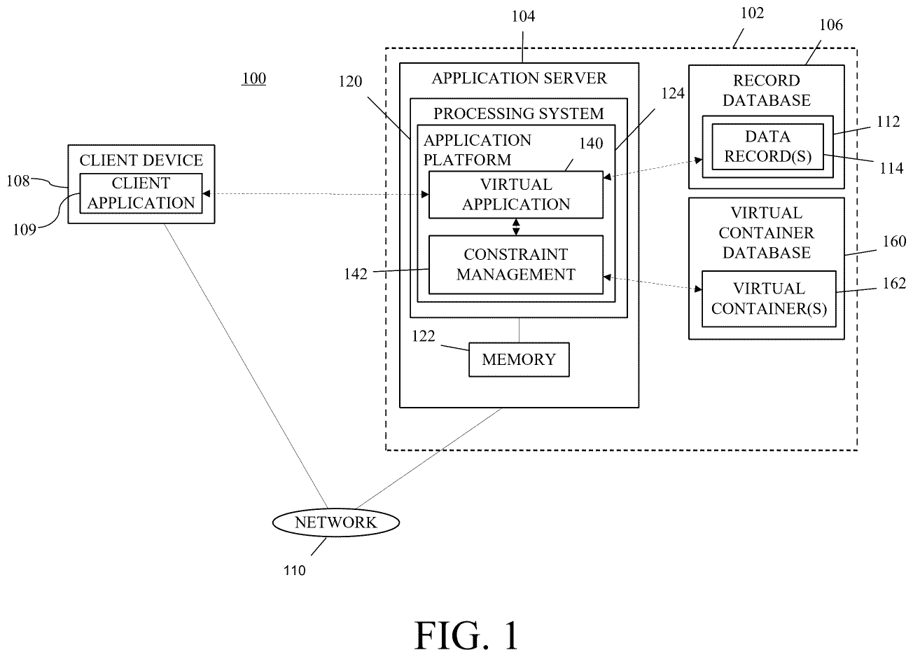

FIG. 1 depicts an exemplary computing system 100 including a database system 102 configurable to provide an application platform 124 capable of concurrently providing instances of one or more virtual applications 140 to client applications 109 at client devices 108 associated with one or more different end users over a communications network 110 (e.g., the Internet or any sort or combination of wired and/or wireless computer network, a cellular network, a mobile broadband network, a radio network, or the like). As described in greater detail below, the application platform 124 at the database system 102 implements, includes or otherwise supports a constraint management service 142 capable of implementing one or more virtual containers 162 for applying constraints across different heterogenous combinations, groupings or other configurations of different types of data records 114 maintained in a record database 106 at the database system 102. That said, it should be appreciated that FIG. 1 is a simplified representation of a computing system 100 and is not intended to be limiting. In this regard, it should be noted that although FIG. 1 depicts a database system 102 including multiple different and distinct databases 106, 160, in practice, one or more of the databases 106, 160 may be integrated or otherwise implemented at a common database. Moreover, in practice, the constraint management service 142 may be implemented independent of the application platform 124 and/or the virtual application 140.

In one or more exemplary implementations, the database system 102 includes one or more application servers 104 that support an application platform 124 capable of providing instances of virtual applications 140, over the network 110, to any number of client devices 108 that users may interact with to view, access or obtain data or other information from one or more data records 114 maintained in one or more data tables 112 at a record database 106 or other repository associated with the database system 102. For example, a record database 106 may maintain, on behalf of a user, tenant, organization or other resource owner, data records 114 entered or created by that resource owner (or users associated therewith), files, objects or other records uploaded by the resource owner (or users associated therewith), and/or files, objects or other records automatically generated by one or more computing processes (e.g., by the server 104 based on user input or other records or files stored in the record database 106). In this regard, in one or more implementations, the database system 102 is realized as an on-demand multi-tenant database system that is capable of dynamically creating and supporting virtual applications 140 based upon data from a common database 106 that is shared between multiple tenants, which may alternatively be referred to herein as a multi-tenant database. Data and services generated by the virtual applications 140 may be provided via the network 110 to any number of client devices 108, as desired, where instances of the virtual application 140 may be suitably generated at run-time (or on-demand) using a common application platform 124 that securely provides access to the data in the record database 106 for each of the various tenants subscribing to the multi-tenant system.

The application server 104 generally represents the one or more server computing devices, server computing systems or other combination of processing logic, circuitry, hardware, and/or other components configured to support remote access to data records 114 maintained in the data tables 112 at the record database 106 via the network 110. Although not illustrated in FIG. 1, in practice, the database system 102 may include any number of application servers 104 in concert with a load balancer that manages the distribution of network traffic across different servers 104 of the database system 102.

In exemplary implementations, the application server 104 generally includes at least one processing system 120, which may be implemented using any suitable processing system and/or device, such as, for example, one or more processors, central processing units (CPUs), controllers, microprocessors, microcontrollers, processing cores, application-specific integrated circuits (ASICs) and/or other hardware computing resources configured to support the operation of the processing system described herein. Additionally, although not illustrated in FIG. 1, in practice, the application server 104 may also include one or more communications interfaces, which include any number of transmitters, receivers, transceivers, wired network interface controllers (e.g., an Ethernet adapter), wireless adapters or other suitable network interfaces that support communications to/from the network 110 coupled thereto. The application server 104 also includes or otherwise accesses a data storage element 122 (or memory), which may be realized as a local disk, hard disk, random access memory (RAM), read only memory (ROM), flash memory, magnetic or optical mass storage, or any other suitable non-transitory short or long term data storage or other computer-readable media, and/or any suitable combination thereof. In exemplary implementations, the memory 122 stores code or other computer-executable programming instructions that, when executed by the processing system 120, are configurable to cause the processing system 120 to support or otherwise facilitate the application platform 124 and related software services that are configurable to support the subject matter described herein.

The client device 108 generally represents an electronic device coupled to the network 110 that may be utilized by a user to access an instance of the virtual application 140 using an application 109 executing on or at the client device 108. In practice, the client device 108 can be realized as any sort of personal computer, mobile telephone, tablet or other network-enabled electronic device coupled to the network 110 that executes or otherwise supports a web browser or other client application 109 that allows a user to access one or more GUI displays provided by the virtual application 140. In exemplary implementations, the client device 108 includes a display device, such as a monitor, screen, or another conventional electronic display, capable of graphically presenting data and/or information along with a user input device, such as a touchscreen, a touch panel, a mouse, a joystick, a directional pad, a motion sensor, or the like, capable of receiving input from the user of the client device 108. Some implementations may support text-to-speech, speech-to-text, or other speech recognition systems, in which case the client device 108 may include a microphone or other audio input device that functions as the user input device, with a speaker or other audio output device capable of functioning as an output device. The illustrated client device 108 executes or otherwise supports a client application 109 that communicates with the application platform 124 provided by the processing system 120 at the application server 104 to access an instance of the virtual application 140 using a networking protocol. In some implementations, the client application 109 is realized as a web browser or similar local client application executed by the client device 108 that contacts the application platform 124 at the application server 104 using a networking protocol, such as hypertext transport protocol secure (HTTPS). In this manner, the client application 109 may be utilized to access or otherwise initiate an instance of a virtual application 140 hosted by the database system 102, where the virtual application 140 provides one or more web page GUI displays within the client application 109 that include GUI elements for interfacing and/or interacting with records 114 maintained at the record database 106.

Still referring to FIG. 1, in exemplary implementations, the record database 106 stores or otherwise maintains data for integration with or invocation by a virtual application 140 in objects organized in object tables 112. In this regard, the record database 106 may include any number of different object tables 112 configured to store or otherwise maintain alphanumeric values or other descriptive information that define a particular instance of a respective type of object associated with a respective object table 112. For example, the virtual application may support a number of different types of objects that may be incorporated into or otherwise depicted or manipulated by the virtual application, with each different type of object having a corresponding object table 112 that includes columns or fields corresponding to the different parameters or criteria that define a particular instance of that object. In some implementations, the record database 106 stores or otherwise maintains application objects (e.g., an application object type) where the application object table 112 includes columns or fields corresponding to the different parameters or criteria that define a particular virtual application 140 capable of being generated or otherwise provided by the application platform 124 on a client device 108. In this regard, the record database 106 may also store or maintain graphical user interface (GUI) objects that may be associated with or referenced by a particular application object and include columns or fields that define the layout, sequencing, and other characteristics of GUI displays to be presented by the application platform 124 on a client device 108 in conjunction with that instance of the virtual application 140.

In exemplary implementations, the record database 106 stores or otherwise maintains additional database objects for association and/or integration with a virtual application 140, which may include custom objects and/or standard objects. For example, in the context of a virtual CRM application, standard database objects may include account, contact, lead, opportunity, quote, invoice, order and/or the like. Additionally, an administrator user associated with a particular resource owner may utilize an instance of a virtual application 140 to create or otherwise define a new custom field to be added to or associated with a standard object, or define a new custom object type that includes one or more new custom fields associated therewith. For example, an administrator user associated with a particular resource owner or tenant may define different custom objects corresponding to the different types of products or services sold or provided by the respective resource owner or tenant, with corresponding custom fields defining attributes of the respective instances of those custom objects. In some implementations, the record database 106 may also maintain metadata that defines or describes the fields, process flows, workflows, formulas, business logic, validation rules, structure and other database components or constructs that may be associated with a particular database object.

In one or more exemplary implementations, the application platform 124 is configurable to facilitate or generate an instance of a virtual application 140 at run-time or on-demand using configured web components associated with the web application that are maintained in a component database coupled to the application server 104. In this regard, the configured web components define the particular fields or parameters of data records 114 to be integrated with, incorporated into or otherwise included in a particular web page GUI display associated with the virtual application 140 for a particular tenant's configuration. For example, a developer of a web application may configure, define or otherwise provide other information for one or more fields of a particular database object type for an instance of a web component template added to a web page GUI display of the virtual application, which, in turn, may be utilized by the application platform 124 and/or a client application 109 to retrieve data from the record database 106 for incorporation within the virtual application 140 by populating or otherwise generating the instance of the configured web component using the retrieved data at run-time or on-demand.

In the illustrated implementation, the database system 102 also includes a virtual container database 160 that stores or otherwise maintains code or files that define or describe the respective virtual containers 162 to be supported by a constraint management service 142 in connection with the virtual application 140. In this regard, depending on the configuration, the virtual containers may be associated with particular resource owners or tenants to limit the scope of the respective constraints defined therein to a particular resource owner or tenant, or alternatively, the virtual containers may be associated with particular types of standard database objects supported by the virtual application 140 or otherwise configured to apply constraints across multiple different resource owners or tenants. As described above, the virtual containers 162 may be defined using a constraint modeling language (CML) that allows for a user to define hierarchical relationships between different types of entities, the respective attributes associated with those different types of entities, the respective relationships or associations between different types of entities, and any constraints to be applied with respect to the attributes and/or associative relationships between different types of entities. In practice, the code, file or other information defining a particular virtual container 162 may be stored or otherwise maintained in the virtual container database 160 along with information identifying the particular tenant and/or database objects to which the particular virtual container 162 applies. In this regard, the constraint management service 142 is configurable to map or otherwise identify the particular virtual containers 162 associated with particular instances of data records 114 in the record database 106 at the database system 102 to identify which virtual containers 162 are to be applied with respect to a particular data record 114 in response to a CRUD operation or other interaction with a particular data record 114 in the record database 106. For example, an administrator user associated with a particular resource owner or tenant may define a particular virtual container 162 to be applied to quote database objects associated with that particular resource owner or tenant, such that when a user of a client device 108 that is associated with that tenant interacts with a quote data record 114 associated with that tenant, the constraint management service 142 identifies the virtual container 162 defined for quote database objects for that tenant to be applied to the quote data record 114 being interacted with, as described in greater detail below.

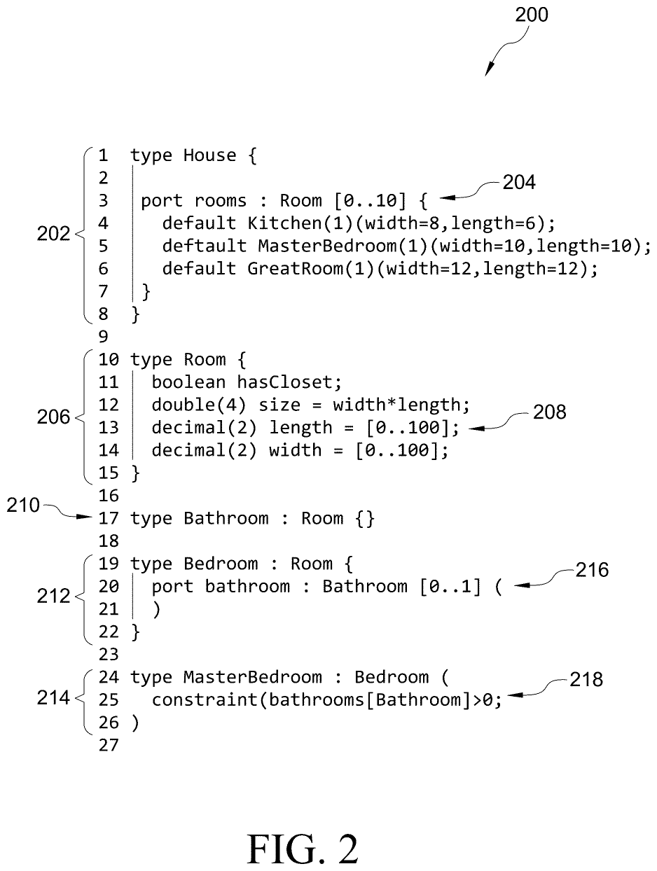

FIG. 2 depicts an exemplary implementation of a virtual container 200 defined using a constraint modeling language (CML) to apply constraints across relationships between different types of data records corresponding to different database object types supported by an application platform and/or virtual application at a database system. For purposes of explanation, FIG. 2 depicts a virtual container 200 defined in CML for a house model; however, it should be appreciated that the subject matter is not limited to any particular type or configuration of product model. The virtual container 200 defines a house type entity 202 that functions as a virtual container prototype for a house product that includes rooms defined by a port 204 to one or more room type entities 206. In this regard, in the illustrated implementation, the port 204 declaration constrains the house type entity to include an associated number of rooms represented by room type entities 206 up to a total maximum number of rooms of 10, and by default, includes at least one kitchen room type entity, a master bedroom room type entity, and a great room room type entity. It should be noted that although FIG. 2 depicts a house type entity 202 defined by port 204, in practice, a top-level product model virtual container may be further defined by additional attributes, ports and constraints.

The room type entity 206 similarly functions as a virtual container prototype for a room subproduct or subcomponent of a house that is defined by attributes 208. The illustrated virtual container 200 also includes child room type entities 210, 212, 214 for bathrooms, bedrooms and master bedrooms which inherit any attributes 208, ports or constraints from the parent room type entity 206 and can extend the parent room type entity 206 with additional ports, constraints or other attributes associated with that respective child type entity 210, 212, 214. For example, the bedroom child room type entity 212 is defined by a port 216 constraining the bedroom to being associated with between zero and one bathroom child room type entity 210, while the master bedroom child room type entity 214 is defined by a constraint 218 requiring the master bedroom to be associated with at least one bathroom child room type entity 210.

Referring to FIG. 2 with reference to FIG. 1, when a user of a client device 108 utilizes a product configurator or CPQ tool of a virtual application 140 to define a quote for a house database object type and corresponding data records 114 associated therewith, the constraint management service 142 analyzes the data records 114 associated with the quote to identify the house virtual container 162, 200 and the different room virtual containers 206, 210, 212, 214 to be associated with the respective data records 114 associated with the quote data record 114. For example, the constraint management service 142 may utilize a field of the quote data record 114 to identify the house data record 114 associated with the quote and then analyzes one or more fields of the house data record 114 to identify the house virtual container 162, 200 for the house data record 114 (e.g., by matching or mapping an identifier for the tenant or other resource owner associated with the data record 114 to an identifier associated with the virtual container 162, 200, matching or mapping a value indicative of a database object type associated with the data record 114 to a database object type associated with the virtual container 162, 202, and/or the like). In a similar manner, the constraint management service 142 utilize fields of the house data record 114 and/or the associated room data records 114 to identify the appropriate room virtual containers 162, 206, 210, 212, 214 for the respective room data records 114 associated with the house data record 114 that was mapped to the virtual containers 200, 202.

After identifying the relevant virtual containers 162 to be associated with the respective data records 114, the constraint management service 142 updates the respective virtual containers 162 to include, incorporate, associate or otherwise reflect the data records 114 mapped to the respective virtual containers 162 to maintain associations between the different data records 114 at the database system 102 using the virtual containers 162. For example, the constraint management service 142 may generate updated CML code for the house product model virtual container 162, 200 to associate the house type entity 202 with the house data record 114 and implement the port relationship 204 with the room type entities 206 that were created or updated to reflect the room data records 114 associated with the house data record 114 with the respective defined attributes for those room data records 114. Thereafter, in response to a CRUD operation or other interaction with the quote data record 114 or a respective house or room data record 114 associated therewith, the constraint management service 142 executes or otherwise implements the updated CML code for the virtual containers 162 to automatically apply the ports or constraints defined therein across the different types of data records 114 associated within the virtual containers 162. For example, the constraint management service 142 may execute the house product model virtual container 162, 200 associated with the quote data record 114 when the user modifies or configures the quote to verify that the quote includes at least one house (and corresponding house database object type data record 114), that that house includes between zero and ten rooms, that those associated rooms include at least one kitchen, master bedroom and great room (and corresponding database object type data records 114), that each of the associated rooms has defined dimensions or size attributes, that any bedrooms are associated with either zero or one bathrooms, and that the master bedroom includes at least one bathroom associated therewith. In response to detecting a violation of a constraint associated with the attributes, ports or other constraints of one or more of the virtual containers 162, the constraint management service 142 provides a corresponding indication of the violation to the virtual application 140 to automatically update one or more fields of the quote, house and/or room data record(s) 114 to identify the particular constraint that was validated. In response the virtual application 140 may automatically update a GUI display associated with the product configurator or CPQ tool to generate a graphical representation of the particular data record 114 that violated a constraint along with a graphical indication of the constraint that was violated based on values for one or more fields of the respective data record 114.

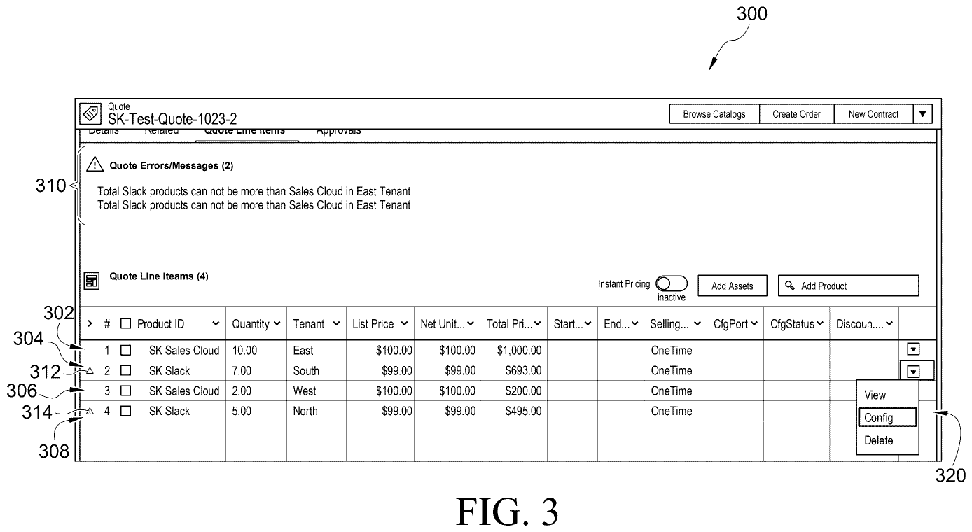

FIG. 3 depicts an exemplary implementation of a quote configuration GUI display 300 suitable for presentation by an instance of a virtual application 140 in connection with a product configurator, CPQ tool or other feature of the virtual application 140. The quote configuration GUI display 300 includes a graphical representation of a quote data record 114 including graphical representations 302, 304, 306, 308 of the respective product data records 114 associated with the quote data record 114 capable of being created, defined or otherwise configured via the quote configuration GUI display 300. FIG. 3 depicts a state of the quote configuration GUI display 300 after user interaction with one or more of the product data records 114 that caused the constraint management service 142 to execute or otherwise implement one or more virtual containers 162 associated with the quote or the products associated therewith to detect violation of one or more constraints on relationships between the different product data records 114 associated with the quote. For example, in the illustrated implementation, the constraint management service 142 detects violation of a constraint associated with a virtual container 162 for the quote data record 114 that limits the number of data records 114 of a first product database object type (“Slack”) that can be associated with the quote based on the number of data records 114 of a second product database object type (“Sales Cloud”) associated with a particular tenant or resource owner (“East Tenant”). As shown, the constraint management service 142 provides a corresponding indication of the violated constraint to the virtual application 140 and/or updates a field of the data records 114 of the first product database object type to include indication of the violated constraint associated with those data records 114. In response, the virtual application 140 generates or otherwise provides graphical indicia 310, 312, 314 of the violated constraint in connection with the respective graphical representations of those data records 114 of the first product database object type violating the constraint.

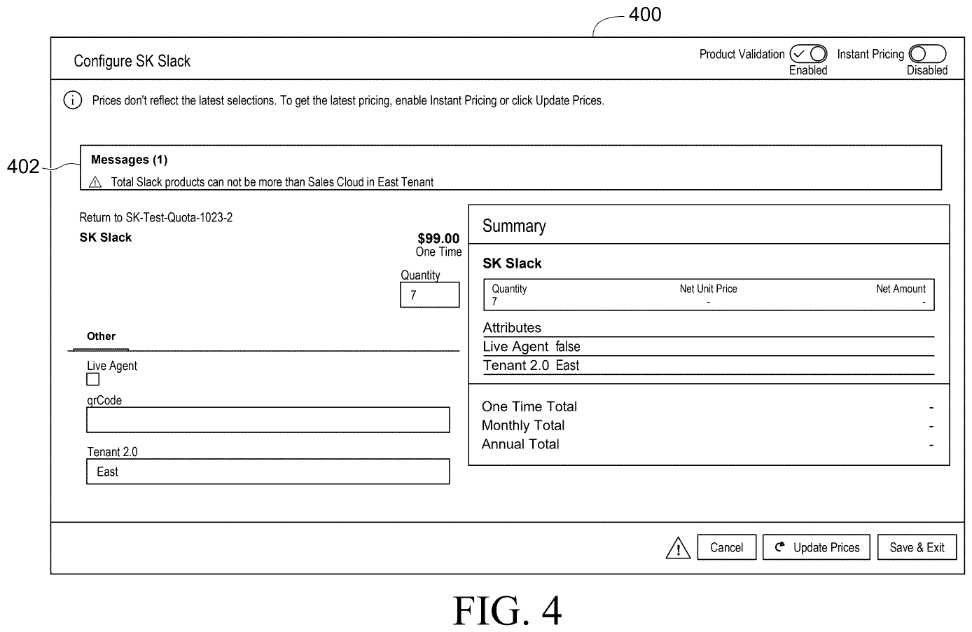

Referring to FIG. 4 with reference to FIG. 3, in exemplary implementations, the quote configuration GUI display 300 includes a GUI element 320 manipulable by a user to modify the configuration of a respective product data record 114 that causes the virtual application 140 to generate a product configuration GUI display 400 that includes a graphical representation of the data record 114 of the first product database object type. The product configuration GUI display 400 includes a graphical indication 402 of the constraint associated with the virtual container 162 violated the values for one or more fields of the respective product data record 114 along with one or more GUI elements manipulable by the user to modify the value for one or more fields of the respective product data record 114 (e.g., the quantity value, the associated tenant and/or the like) to cause the attributes of the product to satisfy the constraint associated with the virtual container 162. In response to user interaction with a GUI element to modify the value of a field of the product data record 114 or otherwise modify the configuration of the product, the constraint management service 142 automatically updates and executes the virtual containers 162 associated with the product and/or quote using the modified value(s) for the attribute(s) of the corresponding product entity corresponding to the respective updated value(s) for the field(s) of the product data record 114 to verify or otherwise confirm that the constraints associated with the virtual containers 162 are satisfied. In response to determining a previously violated constraint has been satisfied, the constraint management service 142 provides a corresponding indication to the virtual application 140 and/or updates a field of the data record 114 to delete or otherwise remove any indication of a previously-violated constraint associated with the data record 114 to cause the virtual application 140 to remove the relevant graphical indicia 310, 312, 402 of the violated constraint from the respective GUI displays 300, 400 associated with the virtual application 140.

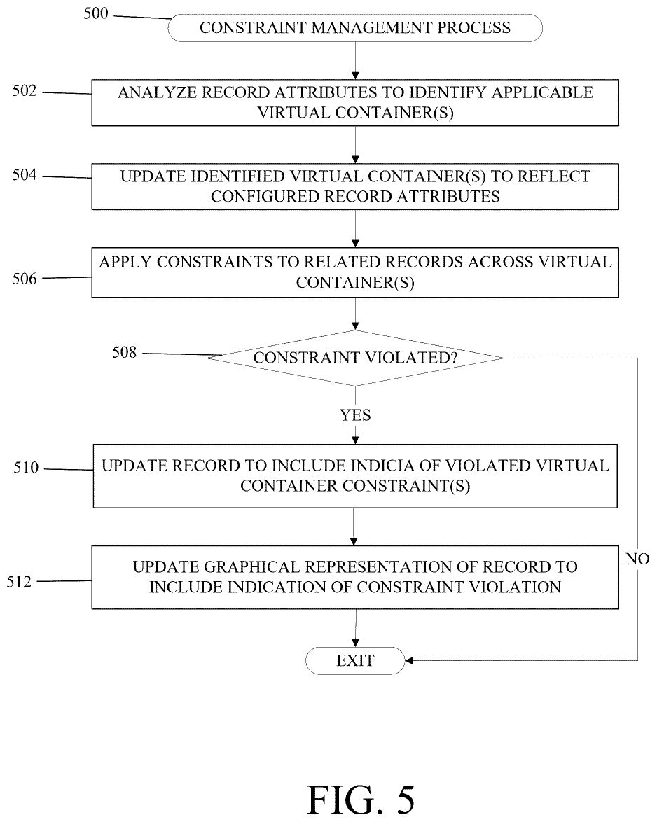

FIG. 5 depicts an exemplary constraint management process 500 suitable for implementation by a constraint management service associated with an application platform to apply constraints across different types of database objects or records at a database system using virtual containers and perform additional tasks, functions, and/or operations described herein. For illustrative purposes, the following description may refer to elements mentioned above in connection with FIGS. 1-4. It should be appreciated that the constraint management process 500 may include any number of additional or alternative tasks, the tasks need not be performed in the illustrated order and/or the tasks may be performed concurrently, and/or the constraint management process 500 may be incorporated into a more comprehensive procedure or process having additional functionality not described in detail herein. Moreover, one or more of the tasks shown and described in the context of FIG. 5 could be omitted from a practical implementation of the constraint management process 500 as long as the intended overall functionality remains intact.

Referring to FIG. 5, with continued reference to FIGS. 1-4, in exemplary implementations, the constraint management process 500 is initiated or otherwise performed in response to user interaction with an instance of a virtual application to perform a CRUD operation with respect to one or more data records at a database system. In this regard, the constraint management process 500 may be initiated by a product configurator, CPQ tool or other software component or feature of an instance of a virtual application 140 in response to user interaction to create, update or otherwise modify one or more configurations, relationships or values associated with one or more data records 114 at the database system 102. For example, a CPQ tool may trigger, invoke or otherwise initiate the constraint management service 142 supporting the constraint management process 500 in response to user selection of a GUI element of a quote configuration GUI display 300 or a product configuration GUI display 400 to modify the values or configurations of one or more data records 114 corresponding to different products associated with a quote.

The constraint management process 500 analyzes record attributes to identify any applicable virtual containers corresponding to the records being interacted with and automatically updates the identified virtual containers to reflect the current state of the records (tasks 502, 504). For example, in response to a user interacting with a GUI display 300, 400 provided by the virtual application 140 to create a quote (e.g., by defining one or more products for the quote) or modifying the configuration or values of one or more products associated with an existing quote, the instance of the virtual application 140 provides corresponding indicia of the data records 114 for the respective quote and products to the constraint management service 142, which, in turn, analyzes the values for the various fields of the different types of data records 114 associated with the quote to identify applicable virtual containers 162 defined for those data records 114. In this regard, the constraint management service 142 may analyze values for one or more fields of the quote data record 114 to identify a virtual container 162 applicable to that quote data record 114 (e.g., by mapping the combination of the database object type and tenant identifier associated with the quote data record 114 to a corresponding virtual container 162) and automatically updates the virtual container 162 to reflect the values for one or more fields of the quote data record 114. For example, the constraint management service 142 may instantiate a quote virtual container object corresponding to the identified virtual container 162 using values for attributes obtained from one or more fields of the quote data record 114.

In a similar manner, for the different types of database objects and corresponding data records 114 associated with that quote data record 114, the constraint management service 142 identifies applicable virtual containers 162 for those types of data records 114 and instantiates one or more virtual container objects corresponding to the identified virtual containers 162 using values for attributes obtained from one or more fields of the respective data records 114. In this regard, in addition to creating a quote type entity representative of the quote data record 114, the constraint management service 142 creates different product type entities representative of the different types of data records 114 associated with the quote data record 114 with the respective associations or relationships defined by the respective fields of the data records 114.

After identifying and mapping the different data records to corresponding virtual container objects, the constraint management process 500 automatically applies constraints to the group of related records across the virtual containers to detect or otherwise identify when the values for one or more fields of the records violates a constraint associated with a virtual container (task 506, 508). For example, after creating the virtual container objects, the constraint management service 142 may execute the CML or other code of the respective virtual container objects to verify that the virtual container objects include the required type, number and/or configuration of ports, attributes or other constraints with respect to one another. For example, the constraint management service 142 may verify a quote associated with a particular tenant includes a particular number or combination of different types of products defined as a part of a rule or other business logic for that particular tenant, and further verify that those of different types of products have the required attributes, ports, associations or relationships, and/or the like that have been defined based on the rules or business logic defined by or for that particular tenant.

When the value for a particular field of a data record causes its corresponding virtual container object representation to violate a constraint associated with that virtual container, the constraint management process 500 automatically updates that data record to include an indication of the violated constraint(s) associated with the virtual container and automatically updates a graphical representation of the data record to include graphical indication of the constraint violation (tasks 512, 514). For example, as described above in the context of FIGS. 3-4, in response to detecting that a value for a quantity field of a product data record violates a constraint on the attribute for the quantity field based on the current configuration of a different type of product data record associated with the quote, the constraint management service 142 may provide a corresponding indication to the virtual application 140 to update a field of the product data record and/or a field of the quote data record to include a string, text, value or other information identifying the particular constraint that was violated with respect to the configuration of that particular product data record. After updating a respective data record 114, the instance of the virtual application 140 may automatically and dynamically update the GUI display associated with the virtual application 140 to reflect the updated value for that field indicating the constraint violation, for example, by automatically generating a graphical representation 310 of the string or text value of the field of the violating product data record 114 and/or automatically providing a graphical indication 312 proximate to or in visual association with the graphical representation 304 of that violating product data record 114.

In this manner, after the constraint management process 500 provides substantially real-time feedback to the user of the particular constraints violated with respect to potentially complex combinations of different types of data records 114 corresponding to different database object types grouped together or otherwise associated with a common quote in a manner that allows the user to modify the configuration of the data records 114 to resolve the constraint without requiring performance of complex queries or other operations on the data records 114 at the database system 102 to apply different constraints across heterogenous combinations of data records 114. Thus, a user using a CPQ tool, product configurator or other feature of the virtual application 140 may ensure the resulting configuration of different combinations of different types of products or services satisfy or otherwise comply with any sort of set of rules or business logic associated with that user's associated tenant, with varying levels of scope and/or complexity, and thereby align with the tenant's marketing strategies, development strategies or other CRM objectives.

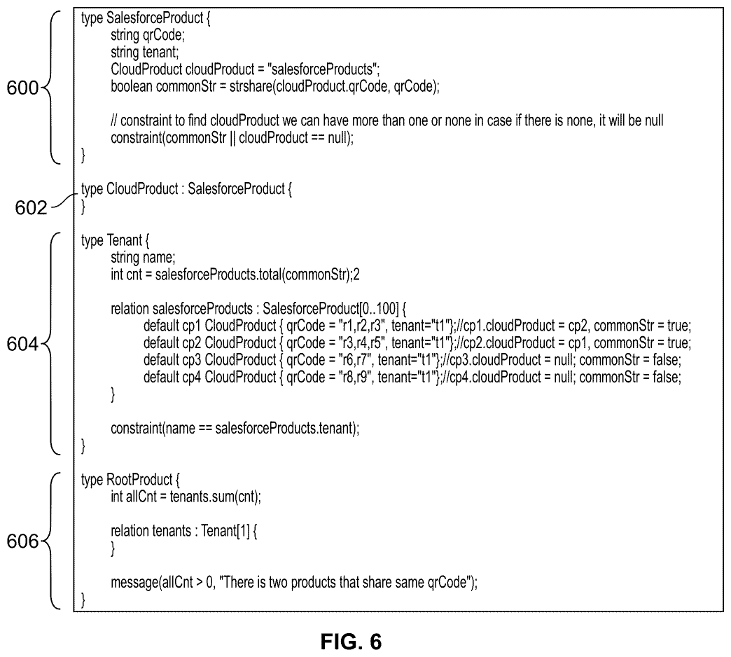

FIG. 6 depicts exemplary CML code for defining an instance variable to bind different virtual containers and corresponding data records of different database object types in connection with the constraint management service applying constraints across relationships between different types of data records corresponding to different database object types in the computing system of FIG. 1 according to some example implementations. In this regard, the instance variable is defined in a manner that allows a search algorithm to find an instance of another data record or corresponding virtual container satisfying the constraint defined for the instance variable, thereby allowing the different virtual containers and/or data records to be bound vis a vis the instance variable in a manner that allows the instance variable (and corresponding relationship between virtual containers and/or data records) to be used in other constraints.

As described above in the context of FIGS. 1-5, CML is a domain-specific language capable of define models for complex systems. For example, in the context of product configuration in a CRM application, constraint models can describe real-world entities and their relationships to each other, and enforce business logic declaratively without the need for extensive code in a general-purpose programming language. The constraint management service 142 compiles CML code into a constraint model and corresponding virtual containers 162 and utilizes the constraint model to facilitate constructing a product configuration that complies with the specified constraints. In practice, to build a constraint model in CML, CML code can be configured to create global properties and settings with fixed values that set up the foundation of the constraint model and define types, which represent entities or objects in the model, similar to classes in object-oriented programming. In this regard, types encapsulate the properties, relationships, constraints and rules for the respective entities, and generally include variables defining the properties or characteristics of a respective type, relationships describing how different types of the model are associated with each other, and constraints defining logical restrictions and enforce rules and conditions on types, variables, and relationships.

In exemplary implementations, variables defined within a type can hold different kinds of data (e.g., strings, numbers, lists, etc.) and data types (e.g., Boolean, date, decimal, integer, etc.), and can be calculated from other values. In this regard, CML supports variable functions such as sum(), min(), and max() that are configurable to calculate values from all variables with the same name in the descendants of the current type. As described below, FIG. 6 depicts an implementation of CML code defining an instance variable configured to cause the constraint management service 142 to search or otherwise choose candidate instances from eligible instances in the constraint model to identify whether a constraint associated with the instance variable is satisfied, and when a candidate instance satisfies the constraints, the constraint management service 142 binds the value of the instance variable to identify the candidate instance(s) satisfying the constraint, thereby enabling constraints to be applied using the bound instance variable. Otherwise, the constraint management service 142 leaves the instance variable unbound and not utilized in other constraints. For an instance variable defined within a type, if the domain declaration is blank, domains are all instances in the configuration and the path to the instance can be specified in the configuration using comma (“,”) delimited paths and period (“.”) delimited relationship names to cause the constraint management service 142 to traverse the ancestors to find relations and check all instances within the relation until collecting all instances to be evaluated for binding the value of the instance variable. For example, a declaration “r1.r2.r3” will cause the constraint management service 142 to traverse the ancestors to find the first relation r1, evaluating all instances in r1 to identify any satisfying the constraint for binding the variable, then finding and evaluating all instances in r2, then finding and evaluating all instances in r3 until all instances have been evaluated.

In the example depicted in FIG. 6, the CML code includes a first code segment 600 defining product type entity (e.g., “type SalesforceProduct”) virtual container, a second code segment 602 defining a child virtual container of the product type entity virtual container (e.g., “type CloudProduct: SalesforceProduct”), a third code segment 604 defining a tenant type entity (e.g., “type Tenant”) virtual container, and a fourth code segment 606 defining another virtual container for purposes of generating alerts based on relationships between instances of the virtual containers defined by the preceding code segments 600, 602, 604.

The product type entity functions as a virtual container prototype for a product, where the product type entity code segment 600 defines a quick-response (QR) code attribute (e.g., “string qrCode”), a tenant attribute (e.g., “string tenant”), and an instance variable attribute for the product, where the instance variable attribute is defined using code identifying where to find a value for the instance variable inside the relationship for the tenant virtual container associated with the respective product virtual container (e.g., “CloudProduct cloudProduct=“salesforceProducts””). The product type entity virtual container code segment 600 also defines a Boolean attribute associated with the product based on whether or not the QR code attribute of a virtual container bound to the product virtual container using the instance variable attribute matches the QR code attribute of the product (e.g., “boolean commonStr=strshare(cloudProduct.qrCode, qrCode)”). The product type entity virtual container code segment 600 also defines a constraint for the Boolean attribute of the product type entity to have a null value when there are no child products associated with the product type entity virtual container (e.g., “constraint(commonStr∥cloudProduct==null)”).

The tenant type entity functions as a virtual container prototype for a tenant associated with a product, where the code segment 604 defines a name attribute (e.g., “string name”) associated with the tenant and an integer attribute (e.g, “int cnt=salesforceProducts.total(commonStr)”) having a value equal to the total number of products associated with the tenant that have a QR code attribute value that matches the QR code attribute of another related product. The tenant type entity code segment 604 also defines the child virtual containers related to the product type entity virtual container and their respective QR code and tenant name attributes (e.g., “relation salesforceProducts: SalesforceProduct[0 . . . 100] {default cp1 CloudProduct {qrCode=“r1,r2,r3”, tenant=“t1”} ; default cp2 CloudProduct {qrCode=“r3,r4,r5”, tenant=“t1”}; default cp3 CloudProduct {qrCode=“r6,r7”, tenant=“t1”}; default cp4 CloudProduct {qrCode=“r8,r9”, tenant=“t1”}”) along with a constraint that the name of the tenant type virtual container matches the tenant name attribute of its related products (e.g., “constraint(commonStr∥cloudProduct==null)”).

As described above in the context of the product type entity code segment 600, the related products defined in the tenant type entity code segment 604 are utilized or referenced by the logic defined by the instance variable attribute for the product type entity to bind the instance variable of the respective product type entity virtual containers based on the relationships between the respective QR code attribute values defined for the respective product of the tenant in relation to the respective QR code attribute values defined for the other product of the tenant. For example, based on a first product defined for the tenant having QR code attribute values of r1, r2 and r3 (e.g., “default cp1 CloudProduct {qrCode=“r1,r2,r3”, tenant=“t1”}”) and a second product defined for the tenant having QR code attribute values of r3, r4 and r5 (e.g., “default cp2 CloudProduct {qrCode=“r3,r4,r5”, tenant=“t1”}”), the instance variable binding logic binds the value of the instance variable of the first product virtual container cp1 to a value indicating the second product virtual container cp2 based on the QR code attribute value r3 matching across the product virtual containers and results in a true value for the Boolean QR code matching attribute of the first product virtual container cp1. Similarly, and the instance variable binding logic binds the value of the instance variable of the second product virtual container cp2 to a value indicating the first product virtual container cp1 based on the QR code attribute value r3 matching across the product virtual containers, resulting in a true value for the Boolean QR code matching attribute of the first product virtual container cp2. In this manner, the instance variable attribute can be utilized to associate, link or otherwise bind a product type entity virtual container to a different instance of the product type entity virtual container, and vice versa.

Still referring to FIG. 6, the illustrated implementation includes an alerting virtual container code segment 606 that defines an integer attribute associated with the virtual container having a value equal to a sum of the values of the integer attribute of the tenants associated with the fourth virtual container code segment 606 (e.g., “int allCnt=tenants.sum(cnt)”). In this regard, by virtue of the matching QR code attribute value between the cp1 and cp2 product virtual containers related to the tenant virtual container, the total number of products having matching QR codes integer attribute evaluates to a value of 2, resulting in a value of 2 for the integer attribute of the alerting virtual container code segment 606. The alerting virtual container code segment 606 also includes a function or logic defined and configured to cause the constraint management service 142 to automatically generate or otherwise provide an alert or similar user notification when the resulting value of the integer attribute is greater than an alerting threshold value (e.g., “message(allCnt>0, “There is two products that share same qrCode”)”). In this manner, the instance variable attribute may be utilized with CML in connection with the constraint management process 500 to associate or otherwise bind different types of products corresponding to different types of database object types or records to allow for additional constraints or other automated actions to be defined for and/or applied to the relationships between the different types of database object types or records using the bound instance variable attribute.

It should be noted that FIG. 6 depicts an implementation of CML code using a message rule constraint that is configurable to show a message (e.g., “There is two products that share same qrCode”) based on a specified condition defined using a basic logical constraint (e.g., the total number of products having matching QR codes is greater than 0). That said, the subject matter described herein is not limited to message rule constraints, and may be implemented in an equivalent manner in the context of any sort of logical constraint capable of being defined using basic logical expressions or operators (e.g., addition (+), subtraction(−), multiplication (*), division(/), remainder (%), equal (==) , not equal (!=) , greater than (>), greater than or equal to (>=), less than (<), less than or equal to (<=) and/or the like) as well as other logical operators supported by CML (e.g., and (&&), conditional operator (?), implication (→), logical equivalent (↔), or (∥), xor (\hat{ }) and/or the like). Additionally, CML may support other types of constraints, such as table constraints (e.g., to enforce value combinations for variables), untable constraints (e.g., the negation of the table constraint), an equal constraint (e.g., to enforce equal values for all variables referred inside the constraint), a distinct constraint (e.g., to enforce unique values for a set of variables referred inside the constraint), an in set operator (e.g., to enforce a constraint in which a variable value must be one of the values in the given domain), an inclusion constraint (e.g., to enforce a relationship variable to include certain values), an exclusion constraint (e.g., to exclude certain values from a relationship variable), a null constraint (e.g., to determine whether a variable is bound to a value (true) or not (false)), and the like. In addition or alternative to the message rule, various implementations of the CML may support a preference rule constraint (e.g., to encourage a constraint solver to satisfy the condition without enforcing the condition if the condition cannot be satisfied), a require rule constraint (e.g., to require certain components in a relationship when specified conditions are met), an exclude rule constraint (e.g., to auto-remove a specific type in a relationship if a certain condition is met), an action rule constraint (e.g., to define simple conditions and rules to automatically trigger or initiate an action with defined parameters), and/or the like.

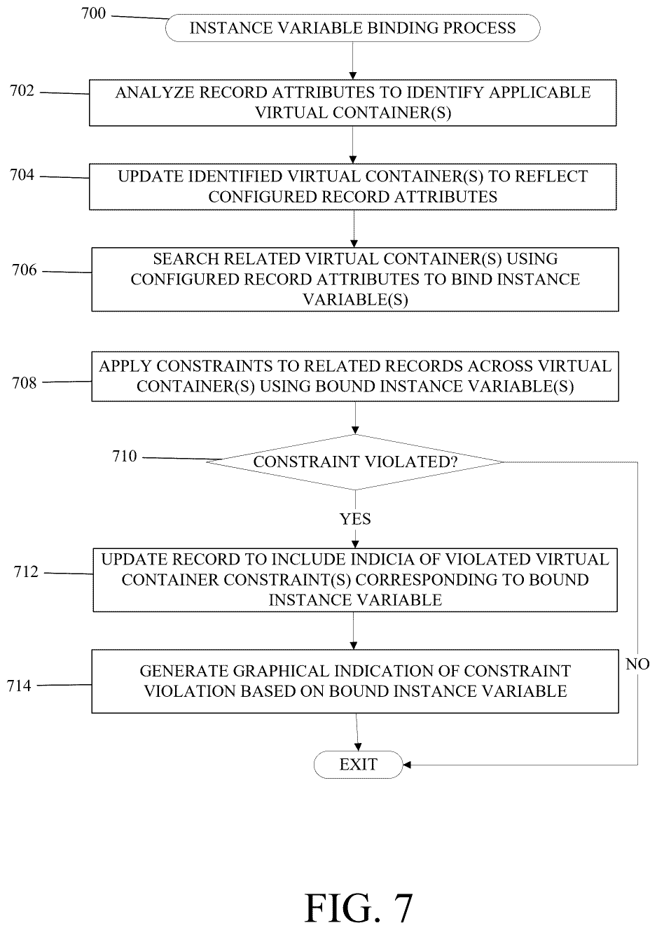

FIG. 7 depicts an exemplary instance variable binding process 700 suitable for implementation by a constraint management service associated with an application platform in connection with the constraint management process 500 to bind an instance variable based on relationships between database objects or records at the database system to apply constraints across different types of database objects or records at the database system using the instance variable and perform additional tasks, functions, and/or operations described herein. For illustrative purposes, the following description may refer to elements mentioned above in connection with FIGS. 1-6. It should be appreciated that the instance variable binding process 700 may include any number of additional or alternative tasks, the tasks need not be performed in the illustrated order and/or the tasks may be performed concurrently, and/or the instance variable binding process 700 may be incorporated into a more comprehensive procedure or process having additional functionality not described in detail herein. Moreover, one or more of the tasks shown and described in the context of FIG. 7 could be omitted from a practical implementation of the instance variable binding process 700 as long as the intended overall functionality remains intact.

Referring to FIG. 7, with continued reference to FIGS. 1-6, in a similar manner as described above, the instance variable binding process 700 is initiated or otherwise performed in response to user interaction with an instance of a virtual application to perform a CRUD operation with respect to one or more data records at a database system, for example, in connection with a product configurator, CPQ tool or other software component or feature of an instance of a virtual application 140 in response to user interaction to create, update or otherwise modify one or more configurations, relationships or values associated with one or more data records 114 at the database system 102. For example, a CPQ tool may trigger, invoke or otherwise initiate the constraint management service 142 supporting the instance variable binding process 700 and constraint management process 500 in response to user selection of a GUI element of a quote configuration GUI display 300 or a product configuration GUI display 400 to modify the values or configurations of one or more data records 114 corresponding to different products associated with a quote. In this regard, the instance variable binding process 700 may be automatically initiated or otherwise performed after the constraint management process 500 analyzes record attributes to identify any applicable virtual containers corresponding to the records being interacted with and automatically updating the identified virtual containers to reflect the current state of the records (e.g., at tasks 502 and 504).

After identifying and mapping the different data records to corresponding virtual container objects, the instance variable binding process 700 automatically searches, traverses or otherwise evaluates related virtual containers defined within a constraint for binding an instance variable of a virtual container object in the context of the constraint model using the configured record attribute values for the variables of the related virtual container objects to identify any related virtual container objects satisfying a constraint for binding the value of the instance variable (task 702). When an instance variable binding constraint is satisfied, the instance variable binding process 700 automatically configures the value of the instance variable to identify or otherwise indicate the related virtual container objects satisfying the instance variable binding constraint (task 704, 706).

For example, in response to a user interacting with a GUI display 300, 400 provided by the virtual application 140 to create a quote (e.g., by defining one or more products for the quote) or modifying the configuration or values of one or more products associated with an existing quote, the instance of the virtual application 140 provides corresponding indicia of the data records 114 for the respective quote and products to the constraint management service 142 to identify and instantiate applicable virtual containers 162 defined for those data records 114. In connection with executing the CML code associated with the constraint model for identifying and instantiating applicable virtual containers 162 for the particular tenant, the constraint management service 142 executes the CML code associated with the instance variable to identify where to find the value for the instance variable within the relationships between types or entities associated with the constraint model and how to determine whether or not the constraint for binding the instance variable is satisfied. For example, referring to FIG. 3 using the example of FIG. 6, the constraint management service 142 analyzes the qrCode variable value for the different product type entities representative of the different types of data records 114 associated with the quote data record 114 to identify whether the qrCode variable value for one of the product type entities matches the qrCode variable value for another one of the product type entities associated with the quote data record 114. In this manner, an instance variable for the different product type entities associated with a quote may be bound based on the configuration of another product type entity associated with the quote, and vice versa.

Still referring to FIG. 7, the instance variable binding process 700 continues by automatically applying one or more constraints to the group of related records across the virtual containers to detect or otherwise identify when the values for the instance variable for one or more of the records violates a constraint associated with the virtual container (task 708). In this regard, in a similar manner as described above, in the context of the constraint management process 500 of FIG. 5, the constraint management service 142 executes the CML or other code of the respective virtual container objects to detect when the value(s) for the instance variable(s) violate one or more constraints for the different types of products defined as a part of a rule or other business logic defined by or for that particular tenant. For example, the constraint management service 142 may bind instance values for virtual containers 162 corresponding to the configuration of products associated with a quote prior to applying constraints to verify the quote satisfies the rules or business logic defined by or for that particular tenant.

When the bound value for an instance variable indicates a relationship between virtual container objects violates a constraint associated with that virtual container, in an exemplary implementation, the instance variable binding process 700 automatically updates that data record to include an indication of the violated constraint(s) associated with the virtual container and automatically initiates one or more actions in response to the violation of the constraint (tasks 710, 712). For example, in a similar manner as described above in the context of FIGS. 3-5, in response to detecting that a bound instance variable value for a product data record and/or a quote data record violates a constraint on relationships between other data records based on the current configuration of a product data record associated with the quote, the constraint management service 142 may provide a corresponding indication to the virtual application 140 to update a field of the product data record and/or a field of the quote data record to include a string, text, value or other information identifying the particular constraint that was violated with respect to the configuration of that particular product data record. In this regard, in some implementations, a field of the product data record and/or a field of the quote data record may include identification of the related data record(s) 114 at the database system 102 corresponding to the related virtual containers that resulted in the bound instance variable value that violates the constraint. Thereafter, a graphical representation of the data record 114 may be correspondingly updated to include graphical indication of the constraint violation. For example, in a similar manner as described above, the instance of the virtual application 140 may automatically and dynamically update the GUI display associated with the virtual application 140 to reflect the bound instance variable constraint violation (e.g., automatically generating a graphical representation of the string or text value of the field of the violating product data record 114 and/or automatically providing a graphical indication proximate to or in visual association with the graphical representation of a violating product data record 114).

As described above in the context of FIG. 6, in one or more implementations, the CML code for the constraint model for a particular tenant may define a message rule constraint that is configurable to cause the constraint management service 142 to automatically generate a message or other user notification when one or more bound instance variables associated with the virtual containers of the tenant's constraint model satisfy a specified condition or logical constraint.

As another example, the CML code for the constraint model for a particular tenant may define an action rule constraint that is configurable to cause the constraint management service 142 to automatically initiate one or more actions at the database system 102 when one or more bound instance variables associated with the virtual containers of the tenant's constraint model satisfy a specified condition or logical constraint. For example, the action rule constraint may cause the constraint management service 142 to invoke an application programming interface (API) or otherwise make an API call at the database system 102 that causes the application platform 124 and/or the virtual application 140 to automatically initiate or perform a particular action based on the bound instance variables. In this regard, referring to the example depicted in FIG. 6, an action rule constraint may be defined to cause the constraint management service 142 to invoke an API that automatically generates a new QR code for a particular product and automatically update a QR code field of the product data record 114 when a bound instance variable value indicates the existing QR code value of the QR code field matches that of another related product data record 114.

In one or more implementations, the action rule constraint has the syntax “rule(condition, action, argument(s)),” where condition is a logical expression defining the constraint for the action rule, action is a string literal that specifies an action that can be interpreted by an API or custom code, and the one or more arguments are string literals, identifiers or other math expressions or domain enclosing to specify values that the constraint management service 142 can retrieve and execute for purposes of determining whether the condition is satisfied. In the context of a CPQ tool or feature, the CPQ tool or feature may include or support an API that supports one or more of hiding attributes, attribute values or product options, disabling attributes, attribute values or product options, or locking line items or line item quantities. Thus, in such embodiments, then the condition is applied to a bound instance variable value that satisfies the constraint, the constraint management service 142 may cause the CPQ tool or feature of the virtual application 140 to automatically hide, disable or lock one or more aspects of the CPQ tool based on the value of a bound instance variable.

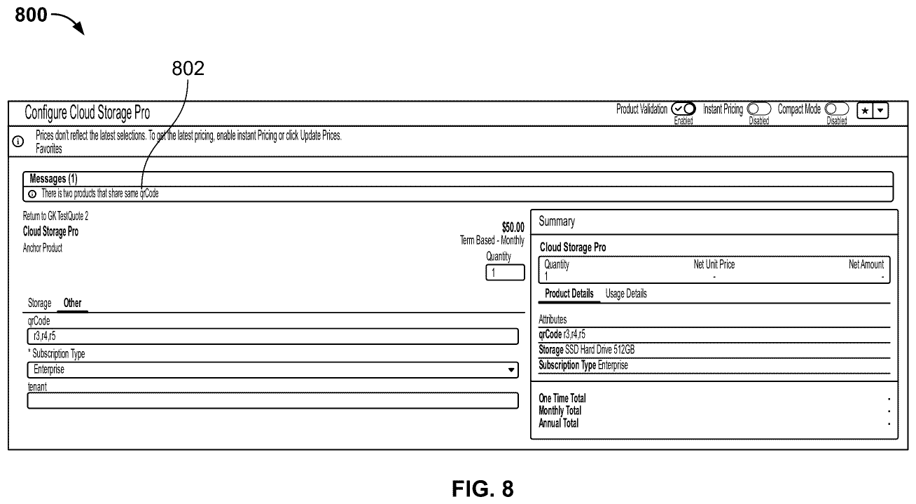

Referring to FIG. 8 with reference to FIGS. 1-7, in exemplary implementations, a product configuration GUI display 800 presented by a virtual application 140 in connection with a CPQ tool may include one or more GUI elements manipulable by a user to modify the configuration of a respective product data record 114 that causes the virtual application 140 to generate the product configuration GUI display 800 that includes a graphical representation of the data record 114 of the first product database object type. In this regard, based on the configured values for a qrCode field of the data record 114, the constraint management service 142 binds the value of the instance variable of the corresponding product virtual container 162 to a value that associates, links or otherwise binds the product type entity virtual container 162 to a different product type entity virtual container 162 that causes the constraint management service 142 to generate a message 802 associated with the message rule defined in the applicable CML code based on the bound instance variable, as described above in the context of FIG. 6.

In one or more implementations, the CML code for defining an instance variable to bind different virtual containers and corresponding data records of different database object types in connection with the constraint management service applying constraints across relationships between different types of data records corresponding to different database object types in the computing system of FIG. 1 may be generated, created or otherwise defined using generative artificial intelligence (AI), for example, based on a large language model (LLM) trained using training data including CML code corresponding to different product models that include their own respective instance variable corresponding relationship between virtual containers and/or data records for one or more different tenants or resource owners associated with the database system 102. For example, a user may input or otherwise provide textual information defining the product model and/or the objective(s) of the user, which, in turn, may be parsed or otherwise processed using natural language processing (NLP) and input to the LLM or other generative AI model to map or otherwise convert the user's input prompt defining the desired product model and/or the objective(s) of the user into corresponding CML code that includes instance variables configurable to be bound in a manner that achieves the user's objectives.

In various implementations, the models and/or modules described herein may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

As described above, the instance variable binding process 700 and the constraint management process 500 and be configured to provide substantially real-time feedback to the user of the particular constraints violated with respect to potentially complex combinations of different types of data records 114 corresponding to different database object types grouped together or otherwise associated with a common quote in a manner that allows the user to modify the configuration of the data records 114 to resolve the constraint without requiring performance of complex queries or other operations on the data records 114 at the database system 102 to apply different constraints across heterogenous combinations of data records 114. Thus, a user using a CPQ tool, product configurator or other feature of the virtual application 140 may ensure the resulting configuration of different combinations of different types of products or services satisfy or otherwise comply with any sort of set of rules or business logic associated with that user's associated tenant, with varying levels of scope and/or complexity, and thereby align with the tenant's marketing strategies, development strategies or other CRM objectives.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read-only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as services) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

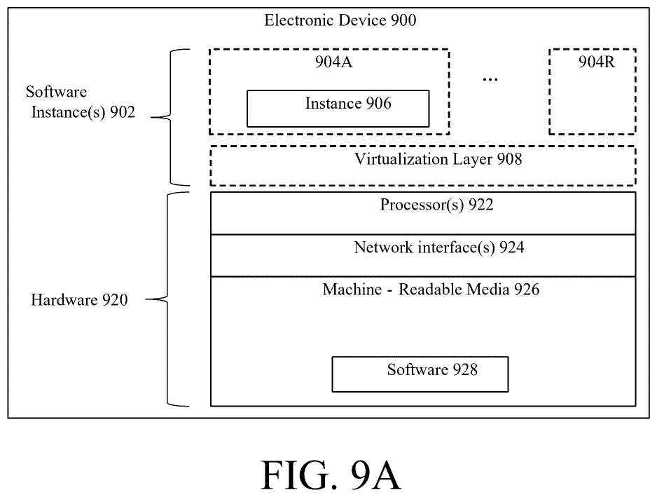

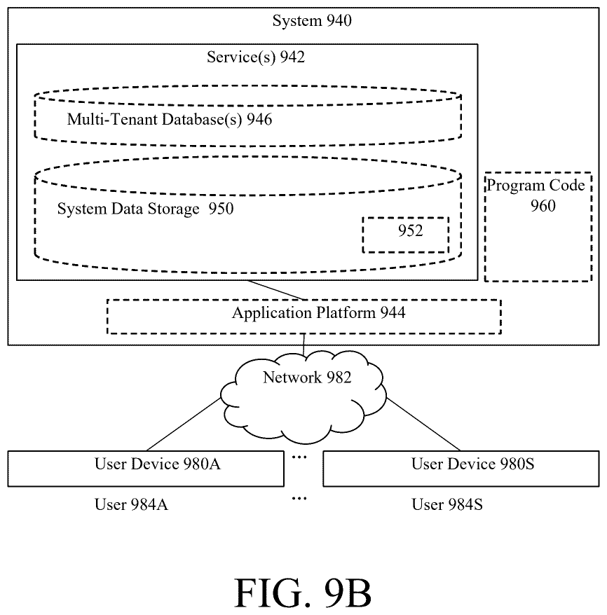

FIG. 9A is a block diagram illustrating an electronic device 900 according to some example implementations. FIG. 9A includes hardware 920 comprising a set of one or more processor(s) 922, a set of one or more network interfaces 924 (wireless and/or wired), and machine-readable media 926 having stored therein software 928 (which includes instructions executable by the set of one or more processor(s) 922). The machine-readable media 926 may include non-transitory and/or transitory machine-readable media. Each of the previously described applications and related services may be implemented in one or more electronic devices 900. In one implementation: 1) each of the clients is implemented in a separate one of the electronic devices 900 (e.g., in end user devices where the software 928 represents the software to implement clients to interface directly and/or indirectly with the virtual application and/or constraint management service(e.g., software 928 represents a web browser, a native client, a portal, a command-line interface, and/or an application programming interface (API) based upon protocols such as Simple Object Access Protocol (SOAP), Representational State Transfer (REST), etc.)); 2) the virtual application and/or constraint management service is implemented in a separate set of one or more of the electronic devices 900 (e.g., a set of one or more server devices where the software 928 represents the software to implement the virtual application and/or constraint management service); and 3) in operation, the electronic devices implementing the clients and the virtual application and/or constraint management service would be communicatively coupled (e.g., by a network) and would establish between them (or through one or more other layers and/or or other services) connections for submitting requests to the virtual application and/or constraint management service. Other configurations of electronic devices may be used in other implementations (e.g., an implementation in which the client and the virtual application and/or constraint management service are implemented on a single one of electronic device 900).

During operation, an instance of the software 928 (illustrated as instance 906 and referred to as a software instance; and in the more specific case of an application, as an application instance) is executed. In electronic devices that use compute virtualization, the set of one or more processor(s) 922 typically execute software to instantiate a virtualization layer 908 and one or more software container(s) 904A-904R (e.g., with operating system-level virtualization, the virtualization layer 908 may represent a container engine (such as Docker Engine by Docker, Inc. or rkt in Container Linux by Red Hat, Inc.) running on top of (or integrated into) an operating system, and it allows for the creation of multiple software containers 904A-904R (representing separate user space instances and also called virtualization engines, virtual private servers, or jails) that may each be used to execute a set of one or more applications; with full virtualization, the virtualization layer 908 represents a hypervisor (sometimes referred to as a virtual machine monitor (VMM)) or a hypervisor executing on top of a host operating system, and the software containers 904A-904R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 928 is executed within the software container 904A on the virtualization layer 908. In electronic devices where compute virtualization is not used, the instance 906 on top of a host operating system is executed on the “bare metal” electronic device 900. The instantiation of the instance 906, as well as the virtualization layer 908 and software containers 904A-904R if implemented, are collectively referred to as software instance(s) 902.

Alternative implementations of an electronic device may have numerous variations from that described above. For example, customized hardware and/or accelerators might also be used in an electronic device.

FIG. 9B is a block diagram of a deployment environment according to some example implementations. A system 940 includes hardware (e.g., a set of one or more server devices) and software to provide service(s) 942, including one or more services configurable to support a virtual application and/or a constraint management service. In some implementations the system 940 is in one or more datacenter(s). These datacenter(s) may be: 1) first party datacenter(s), which are datacenter(s) owned and/or operated by the same entity that provides and/or operates some or all of the software that provides the service(s) 942; and/or 2) third-party datacenter(s), which are datacenter(s) owned and/or operated by one or more different entities than the entity that provides the service(s) 942 (e.g., the different entities may host some or all of the software provided and/or operated by the entity that provides the service(s) 942). For example, third-party datacenters may be owned and/or operated by entities providing public cloud services (e.g., Amazon. com, Inc. (Amazon Web Services), Google LLC (Google Cloud Platform), Microsoft Corporation (Azure)).

The system 940 is coupled to user devices 980A-980S over a network 982. The service(s) 942 may be on-demand services that are made available to one or more of the users 984A-984S working for one or more entities other than the entity which owns and/or operates the on-demand services (those users sometimes referred to as outside users) so that those entities need not be concerned with building and/or maintaining a system, but instead may make use of the service(s) 942 when needed (e.g., when needed by the users 984A-984S). The service(s) 942 may communicate with each other and/or with one or more of the user devices 980A-980S via one or more APIs (e.g., a REST API). In some implementations, the user devices 980A-980S are operated by users 984A-984S, and each may be operated as a client device and/or a server device. In some implementations, one or more of the user devices 980A-980S are separate ones of the electronic device 900 or include one or more features of the electronic device 900.

In some implementations, the system 940 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 940 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 940 may include an application platform 944 that enables PAAS for creating, managing, and executing one or more applications developed by the provider of the application platform 944, users accessing the system 940 via one or more of user devices 980A-980S, or third-party application developers accessing the system 940 via one or more of user devices 980A-980S.

In some implementations, one or more of the service(s) 942 may use one or more multi-tenant databases 946, as well as system data storage 950 for system data 952 accessible to system 940. In certain implementations, the system 940 includes a set of one or more servers that are running on server electronic devices and that are configured to handle requests for any authorized user associated with any tenant (there is no server affinity for a user and/or tenant to a specific server). The user devices 980A-980S communicate with the server(s) of system 940 to request and update tenant-level data and system-level data hosted by system 940, and in response the system 940 (e.g., one or more servers in system 940) automatically may generate one or more Structured Query Language (SQL) statements (e.g., one or more SQL queries) that are designed to access the desired information from the multi-tenant database(s) 946 and/or system data storage 950.

In some implementations, the service(s) 942 are implemented using virtual applications dynamically created at run time responsive to queries from the user devices 980A-980S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 962 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 944 includes an application setup mechanism that supports application developers' creation and management of applications, which may be saved as metadata by save routines. Invocations to such applications, including by the virtual application and/or constraint management service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 982 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a third Generation Partnership Project (3GPP) protocol, a fourth generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 940 and the user devices 980A-980S.

Each user device 980A-980S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 940. For example, the user interface device can be used to access data and applications hosted by system 940, and to perform searches on stored data, and otherwise allow one or more of users 984A-984S to interact with various GUI pages that may be presented to the one or more of users 984A-984S. User devices 980A-980S might communicate with system 940 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 980A-980S might include an HTTP client, commonly referred to as a “browser,” for sending and receiving HTTP messages to and from server(s) of system 940, thus allowing users 984A-984S of the user devices 980A-980S to access, process and view information, pages and applications available to it from system 940 over network 982.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

1. A method of managing records at a database system, the method comprising:
identifying, at the database system, a virtual container defining a constraint for a plurality of records at the database system based on one or more fields of the plurality of records, the plurality of records including a first database record of a first object type and a second database record of a second object type different from the first object type; and
after an operation with respect to the first database record at the database system:
updating a second virtual container corresponding to the first database record having a first variable value based on the one or more fields of the first database record to apply the constraint associated with the virtual container to a third virtual container corresponding to the second database record having a second variable value based on the one or more fields of the second database record to identify the first database record satisfying the constraint with respect to the second database record based on a relationship between the first variable value and the second variable value, resulting in a bound value for an instance variable of the second virtual container corresponding to the first database record satisfying the constraint; and
in response to determining the bound value for the instance variable satisfies a condition of the constraint:
automatically updating a field of the first database record satisfying the constraint to include information identifying the constraint violated by the first database record; and
automatically updating, by the database system, a graphical user interface (GUI) display at a client application at a client device over a network to include a graphical indication of the constraint violated by the first database record.

2. The method of claim 1, further comprising; automatically generating a message indicative of the first database record satisfying the constraint; and
displaying a graphical representation of the message on the GUI display at the client device.

3. The method of claim 1, further comprising:
automatically disabling modification of an attribute of the first database record satisfying the constraint; and
comprises modifying presentation of a GUI element associated with the attribute at the client device to indicate the modification of the attribute of the first database record is disabled.

4. The method of claim 1, further comprising:
automatically hiding an attribute of the first database record satisfying the constraint; and
automatically removing a graphical representation of the attribute from the GUI display at the client device in response to automatically hiding the attribute.

5. The method of claim 1, further comprising:
automatically locking an attribute of the first database record satisfying the constraint; and
modifying presentation of a GUI element associated with the attribute at the client device to indicate the attribute of the first database record is locked.

6. The method of claim 1, wherein:
identifying the virtual container comprises identifying a quote type virtual container object defining the constraint for the plurality of records at the database system; and
updating the second virtual container comprises applying the constraint associated with the quote type virtual container object to respective product type virtual container objects corresponding to the respective records of the plurality of records at the database system to identify the first database record satisfying the constraint with respect to the second database record based on the one or more fields of the first database record, resulting in the bound value for the instance variable of at least one of the respective product type virtual container objects.

7. The method of claim 1, further comprising:
generating a quote configuration GUI display at the client application at the client device, the quote configuration GUI display including GUI elements for modifying the one or more fields of the plurality of records;
automatically generating a message based on the bound value for the instance variable in response to the first database record satisfying the constraint; and
displaying the message on the quote configuration GUI display.

8. The method of claim 1, further comprising automatically initiating an application programming interface (API) to perform an action with respect to the one or more fields of the first database record satisfying the constraint.

9. The method of claim 1, wherein updating the second virtual container comprises binding the instance variable of the second virtual container corresponding to the first database record to the bound value indicating the third virtual container corresponding to the second database record when a first value for a first field of the first database record matches a second value for a second field of the second database record.

10. (canceled)

11. The method of claim 1, wherein the instance variable associated with the second virtual container is generated using generative artificial intelligence based on a large language model (LLM) trained using training data including constraint modeling language (CML) code.

12. A non-transitory machine-readable storage medium that provides instructions that, when executed by a processor, are configurable to cause the processor to perform operations comprising:
identifying a virtual container defining a constraint for a plurality of records at a database system based on one or more fields of the plurality of records, the plurality of records including a first database record of a first object type and a second database record of a second object type different from the first object type; and
after an operation with respect to the first database record at the database system:
updating a second virtual container corresponding to the first database record having a first variable value based on the one or more fields of the first database record to apply the constraint associated with the virtual container to a third virtual container corresponding to the second database record having a second variable value based on the one or more fields of the second database record to identify the first database record of the plurality of records satisfying the constraint with respect to the second database record based on a relationship between the first variable value and the second variable value, resulting in a bound value for an instance variable of the second virtual container corresponding to the first database record satisfying the constraint; and
in response to determining the bound value for the instance variable satisfies a condition of the constraint:
automatically updating a field of the first database record satisfying the constraint to include information identifying the constraint violated by the first database record; and
automatically updating, by the database system, a graphical user interface (GUI) display at a client application at a client device over a network to include a graphical indication of the constraint violated by the first database record.

13. The non-transitory machine-readable storage medium of claim 12, wherein the instructions are configurable to cause the processor to:
automatically generate a message indicative of the first database record satisfying the constraint; and
display a graphical representation of the message on the GUI display at the client device.

14. The non-transitory machine-readable storage medium of claim 12, wherein the instructions are configurable to cause the processor to:
automatically disable modification of an attribute of the first database record satisfying the constraint; and
modify presentation of a GUI element associated with the attribute on the GUI display at the client device to indicate the modification of the attribute of the first database record is disabled.

15. The non-transitory machine-readable storage medium of claim 12, wherein the instructions are configurable to cause the processor to:
automatically hide an attribute of the first database record satisfying the constraint; and
automatically remove a graphical representation of the attribute from the GUI display at the client device in response to automatically hiding the attribute.

16. The non-transitory machine-readable storage medium of claim 12, wherein the instructions are configurable to cause the processor to:
automatically lock an attribute of the first database record satisfying the constraint; and
modify presentation of a GUI element associated with the attribute on the GUI display at the client device to indicate the attribute of the first database record is locked.

17. The non-transitory machine-readable storage medium of claim 12, wherein the instructions are configurable to cause the processor to:
identify a quote type virtual container object defining the constraint for the plurality of records at the database system; and
apply the constraint associated with the quote type virtual container object to respective product type virtual container objects corresponding to the respective records of the plurality of records at the database system to identify the first database record satisfying the constraint with respect to the second database record based on the one or more fields of the first database record, resulting in the bound value for the instance variable of at least one of the respective product type virtual container objects.

18. The non-transitory machine-readable storage medium of claim 12, wherein the instructions are configurable to cause the processor to:
generate a quote configuration GUI display at the client application at the client device, the quote configuration GUI display including GUI elements for modifying the one or more fields of the plurality of records;
automatically generate a message based on the bound value for the instance variable in response to the first database record satisfying the constraint; and
display the message on the quote configuration GUI display.

19. The non-transitory machine-readable storage medium of claim 12, wherein the instructions are configurable to cause the processor to automatically initiate an application programming interface (API) to perform an action with respect to the one or more fields of the first database record satisfying the constraint.

20. The non-transitory machine-readable storage medium of claim 12, wherein the instructions are configurable to cause the processor to bind the instance variable of the second virtual container corresponding to the first database record to the bound value indicating the third virtual container corresponding to the second database record when a first value for a first field of the first database record matches a second value for a second field of the second database record.
